(19) United States
(12) Patent Application Publication
(10) Pub. No.: US 2022/0346611 A1
(43) Pub. Date: Nov. 3, 2022

(54) METHOD FOR BRINGING CLEANING ROBOTS INTO AND OUT OF A TROLLEY, AND CLEANING SYSTEM

(71) Applicant: Miele & Cie. KG, Guetersloh (DE)

(72) Inventors: Nicolas Stroop, Bielefeld (DE); Mathis Budke, Bielefeld (DE)

(21) Appl. No.: 17/735,657

(22) Filed: May 3, 2022

(30) Foreign Application Priority Data
May 3, 2021 (BE) 2021/5352

(51) Int. Cl. A47L 9/00; A47L 9/28; A47L 11/40; G05D 1/02; B62B 3/10

(52) U.S. Cl. CPC A47L 9/0063; A47L 9/2852; A47L 11/4011; A47L 11/4091; G05D 1/0225; B62B 3/10; A47L 2201/04; G05D 2201/0215; B62B 2202/50

(57) ABSTRACT

A method for bringing cleaning robots into and out of a trolley, and cleaning system, in which each cleaning robot is automatically brought into the trolley individually and the cleaning robots are automatically brought out of the trolley in an order depending on the cleaning effort assigned to them or in a sequence specified by a user of the trolley. A cleaning system comprises a trolley and a multiplicity of cleaning robots configured to carry out the method.

### RELATED APPLICATIONS

The present disclosure claims priority to and the benefit of Belgium Application 2021/5352 filed on May 3, 2021, the entire contents of which are incorporated herein by reference.

### TECHNICAL FIELD

The disclosure relates to a method for bringing cleaning robots into and out of a trolley and to a cleaning system. In particular, the disclosure relates to a method for bringing cleaning robots into and out of a trolley in order to stow them away or to have their cleaning tasks carried out, and to a cleaning system which is designed to carry out the method.

### BACKGROUND

A cleaning station that has a fleet of several autonomous or self-propelled cleaning robots and one or more base stations that is or are designed for emptying and power supply is used in particular for cleaning larger commercial floor areas, such as sales areas in fashion stores. The following problems arise here: During the non-active cleaning time, when the cleaning robots are not performing any cleaning tasks, a fleet or the individual cleaning robots of the fleet together with their base station(s) take up a lot of space. In the commercial application context, this demanding space requirement of the cleaning system is problematic. In retail areas in particular, every occupied square meter represents a direct encroachment on the profitability of the business in question. In addition, the appearance of the goods can be adversely affected by the robots standing around. There is also a risk that robots will be stolen or damaged outside of the active cleaning time.

In order to avoid these problems, it is advantageous if the cleaning robots of the fleet are brought out to the area to be cleaned at the beginning of each cleaning operation and removed from the area to be cleaned and safely stowed away after cleaning is complete. Bringing out and removing the robots should be carried out as autonomously as possible without manual activities by personnel, so that personnel costs do not have a negative impact on profitability. DE 10 2019 110 539 A1 discloses a cleaning station in the form of a robot for transporting self-propelled cleaning robots, comprising a drive device for autonomous movement over a floor surface. The robot comprises a sensor device for detecting its surroundings, a storage device for the cleaning robots, and a movement device for moving the cleaning robots which is designed in such a way that it can receive one of the cleaning robots from the floor surface and place it into the storage device of the robot.

We have discovered the robot has the following disadvantages: There is no specific solution for the elements and how the movement system works. It is not possible to bring the cleaning robots into or out of individual, specific storage units in a targeted manner. In addition, the robot does not know which cleaning robot is stored in which storage unit and can therefore not access specific cleaning robots in a targeted manner. This means that individual, specific cleaning robots cannot be removed. This, inter alia, is necessary in order to bring individual cleaning robots to the area in a targeted manner, depending on the task. This is also necessary in order to be able to access certain cleaning robots with different capabilities and/or operation requirements, for example in the case of a fleet consisting of several vacuum robots and a wiping robot. Due to the fact that the order in which the cleaning robots are brought out is not defined, no intelligent, needs-based output management system is provided. There is no logic for bringing out and collecting the cleaning robots. Rather, the cleaning robots are randomly removed from storage. Therefore, it may be the case that cleaning robots with the least cleaning effort are the first to be brought out from the robot. Consequently, the robot may not be being used as efficiently as possible.

### SUMMARY

The disclosure therefore addresses the problem of providing a method for bringing cleaning robots into and out of a trolley, and a cleaning system in which the cleaning robots are not damaged when they are brought into or out of the trolley, and can be brought into and out of individual, specific storage units in a targeted manner.

According to the disclosure, this problem is solved by a method comprising the features of claim 1 and a cleaning system comprising the features of claim 10. Advantageous embodiments and developments of the disclosure result from the subsequent dependent claims.

The advantages that can be achieved with the disclosure are that the cleaning system knows which cleaning robot is stored in which storage compartment and can therefore access specific cleaning robots in a targeted manner. This means that individual, specific cleaning robots can be removed. This prevents cleaning robots with the least amount of cleaning effort from being brought out first onto an area to be cleaned. This results in efficient use of the cleaning system and ultimately higher cleaning performance per use. Information on position and direction depends on an operational set-up or working position of the cleaning system, in particular of the trolley.

The disclosure relates to a method for bringing cleaning robots into and out of a trolley, in which each cleaning robot is automatically brought into the trolley individually and the cleaning robots are automatically brought out of the trolley in an order depending on the cleaning effort assigned to them or in an order defined by a user of the trolley.

Therefore, the bringing in and out is carried out intelligently. This means that the orders in which the cleaning robots are brought into and out of the trolley are determined as required by the user or automatically by a controller of the trolley. In an alternative embodiment, the order in which said robots are brought in and out can also be calculated by an external server, for example by a cloud server, and transmitted to the trolley and/or the cleaning robots.

For example, it is expedient firstly to place the cleaning robots that have to undertake the greatest cleaning effort onto the area to be cleaned. In a preferred embodiment, corresponding cleaning, task, and/or map data and an ID of the individual cleaning robots are transmitted from the cleaning robots to the trolley in order to bring out the cleaning robots from the trolley, and the trolley uses these data to calculate the output order of the cleaning robots. For automatically bringing out the cleaning robots, the respective cleaning, task, and/or map data and the ID of the individual cleaning robots, including the area to be cleaned, time slot for cleaning, time required, etc., are preferably transmitted to the controller of the trolley. The controller preferably uses these data to determine a sensible bringing out sequence for the cleaning robots. For this purpose, the task/map data of the individual cleaning robots are preferably collated and compared within the controller of the trolley. An algorithm is used to bring the data into a logical order that benefits the cleaning scenario stored by the user as efficiently as possible. In an alternative embodiment, the fleet management of a trolley and the cleaning robots arranged on it takes place via a server, in particular a cloud server. The organization and calculation of all cleaning, task and/or map data, including the resulting bringing out sequence for all cleaning robots involved, takes place on the server. Said robots and the trolley are managed, organized, and controlled by the server as system components.

The data and the ID of the cleaning robots can preferably be accessed and/or determined by the controller of the trolley. Technical variants in the form of Bluetooth, WiFi, infrared, or serial communication via the charging contacts are conceivable as the communication interface between the controller of the trolley and the cleaning robots. Within the controller, the individual cleaning robot data transmitted via the communication interface are preferably linked to identifiers of corresponding end position sensors of the trolley. This ensures that it is stored within the cleaning system at all times which cleaning robot is where in the trolley. In this way, it is possible to remove a specific cleaning robot.

Each cleaning robot is preferably brought into the trolley as soon as it sends the trolley a signal to bring it in. As a result, the cleaning robots can be brought in in a targeted manner after the cleaning operation has been completed. The order in which said robots are brought in after the end of the operation is preferably determined automatically and as needed. This means that, after the end of the operation, each cleaning robot reports an individual request to the controller to be stored and is then stored directly. If several cleaning robots end their operation at the same time, the receiving requests within the controller are preferably placed in a sequence. The sequence is preferably based on the current distance of the individual cleaning robots from the trolley. The cleaning robot with the shortest distance is preferably brought in first. In a further embodiment, each cleaning robot is brought into the trolley in a sequence specified by a user. This allows the user to set the sequence in which the robots are brought in on an individual basis.

In a preferred embodiment, the trolley has a multiplicity of storage compartments, and, for each of the cleaning robots, a corresponding storage compartment of the plurality of storage compartments is determined, into which it is automatically brought. The cleaning robots can be assigned to individual storage compartments either permanently or variably. A variable assignment may be expedient if the bringing out sequence changes for the next operation. Preferably, the cleaning robot that is to be brought out first upon the next operation is brought into the bottom storage compartment. The storage compartments are preferably stacked vertically one above the other.

When and/or after one of the cleaning robots is brought into the specific storage compartment, its cleaning, task and/or map data and its ID are preferably linked to the specific storage compartment.

In a preferred embodiment, bringing in one of the cleaning robots comprises the following steps of driving a cleaning robot to be brought in onto a receiving element of a lift system of the trolley, moving the receiving element vertically up to the specific storage compartment, and driving the cleaning robot into the storage compartment. Bringing out one of the cleaning robots preferably comprises the following steps of vertically moving the receiving element of the lift system to the specific storage compartment, driving the cleaning robot stowed in the storage compartment onto the receiving element, vertically moving the receiving element until it reaches a substrate on which the trolley is standing, and driving the cleaning robot from the receiving element onto the substrate. The storage compartments are preferably stacked vertically one above the other.

The lift system preferably comprises the receiving element for receiving one of the cleaning robots. Said element is preferably designed as two vertically movable loading ramps, which are connected to one another via a web so that they can be moved synchronously. The receiving element is preferably moved according to a “forklift” principle with the aid of two cable winches running synchronously. Other mechanical forms are also conceivable here, such as a pinion which is moved vertically on a stationary toothed rack, or a threaded spindle, which moves a non-rotating carriage vertically. The cable winches are preferably coupled to one another by a shaft. An electric motor is preferably attached to the shaft and is moved on command of the controller of the trolley. Furthermore, the lift system preferably has two cables which are brought into the desired vertical movement direction by means of deflection rollers. The ropes are preferably connected to one of two carriages, which, in turn, have a fixed connection to the web. The carriages are preferably guided vertically using a guide rod and a guide channel. Canting of the carriages is preferably prevented by two rollers each that are attached to the carriages and rest or roll on the surfaces of the guide channel.

The precise approach to the storage compartments is preferably carried out using end position sensors. For this purpose, corresponding sensors and/or actuators are preferably installed on the storage compartments themselves and on the web. If the controller gives the command to bring out one of the cleaning robots from its storage compartment, the carriages together with the bridge and loading ramps preferably move to a defined end position directly in front of the corresponding storage compartment. If the end position is reached, the controller sends a start signal to the corresponding cleaning robot, preferably via the communication interface, so that it can leave its storage compartment and drive onto the receiving element.

Alternatively, the approach of the storage compartments can take place by means of a stepper motor, which detects the revolutions made and transmits them to the controller. After a defined number of revolutions, the controller switches off the electric motor. Likewise, a rotation sensor on a rotating component can record the number of rotations made and transmit it to the controller.

In a preferred embodiment, while the cleaning robot to be deployed is moving out of the storage compartment, its end position is detected. If the receiving element is arranged in front of one of the storage compartments, the cleaning robot in question drives, preferably after receiving the start signal, from its storage compartment over the web onto the loading ramps. The end position of the cleaning robot can be detected via crash sensors installed in the cleaning robot. Alternatively, the cleaning robot can be given the exact distance to travel from the storage compartment. The cleaning robot can determine the distance to a charging contact arranged in the storage compartment using a LIDAR sensor or odometrically by means of sensory determination of the path traveled and thus control the route of the journey. This prevents the cleaning robot from falling off the trolley while being brought out. The cleaning robots preferably move backward out of their storage compartments.

The cleaning robot to be brought in or out is preferably in a pause mode while it is arranged on the receiving element and is being moved by the lift system. The cleaning robot preferably stops driving out of the storage compartment independently and enters pause mode as soon as the end of the receiving element, such as the loading ramp, is reached. The cleaning robot preferably detects its position itself and sends a signal to the controller that it has moved completely out of the storage compartment and that the pause mode has been activated. After receiving the signal that the cleaning robot has completely moved out of the storage compartment and the pause mode is activated, the controller preferably gives a command, whereupon the electric motor preferably moves the shaft so that the receiving element together with the cleaning robot is moved downward in the direction of the substrate on which the trolley is standing.

In an alternative embodiment, the trolley preferably detects the reversing movement of the cleaning robot out of the storage compartment. A position sensor installed at the entrance to the storage compartment can be used to determine when the cleaning robot has completely driven out of the storage compartment and is at the end of the receiving element. In this case, different types of end position sensors such as light-based, magnetic, mechanical, etc. can, in turn, be used. When the end position is reached, the controller preferably sends a signal to the cleaning robot to pause and then sends an additional signal to the electric motor to move the receiving element downward in the direction of the substrate. This variant can be used redundantly to the first variant. This protects against the error case in which the cleaning robot drives beyond the end of the receiving element and falls out of the trolley. This also prevents a second error case in which the lift system starts the vertical movement without the cleaning robot having already reached its end position. The receiving element is preferably provided with a rubberized, non-slip surface. This ensures that the cleaning robot does not fall off the receiving element during the vertical movement if the trolley is not aligned completely horizontally or if the trolley is hit or the like.

If the receiving element together with the cleaning robot reaches the substrate at the end of the vertical movement, this is preferably detected by another end position sensor of the trolley and the controller stops the electric motor.

In a preferred embodiment, the cleaning robot to be brought out receives a signal to start cleaning when it is and/or after it has been brought out of the trolley. The cleaning robot then leaves the receiving element and carries out its cleaning task.

When leaving the lift system, the cleaning robot to be brought out preferably records its position as the start point and end point of its cleaning to be carried out in map data stored in said robot or in a map to be newly created. The trolley preferably has electronic components such as an infrared interface which is located directly in front of the cleaning robot when the receiving element together with the cleaning robot is arranged on the substrate. The cleaning robot preferably detects the infrared source directly in front of it and records said source on its digital map as the start point and end point of its cleaning activity. The cleaning robot then preferably drives away from the receiving element and begins cleaning the area to be cleaned.

After one of the cleaning robots is deployed, the trolley preferably detects whether said cleaning robot has left the trolley. The controller of the trolley can preferably determine via the infrared interface whether the cleaning robot has left the receiving element. The correct positioning and presence of the cleaning robot on the receiving element should preferably also be detected by an additional sensor, for example a light barrier. If necessary, said barrier can also detect the cleaning robot leaving. The receiving element is reset to its initial state and, if necessary, begins to bring out other cleaning robots stored in the trolley onto the floor area to be cleaned. If all cleaning robots provided for cleaning the floor surface or substrate have been brought out, the receiving element preferably remains in its lower end position on the substrate.

When one of the cleaning robots finishes its cleaning task, it preferably goes back to the trolley autonomously. If the cleaning robot had a pre-existing map available at the start of the cleaning, the current position of the trolley was preferably defined as the start point on said map. If there was no map in the cleaning robot at the beginning of the cleaning, the position of the trolley is preferably defined as the zero point of a newly constructed map.

Furthermore, an IR guide beam, which the trolley emits, can be used for precisely locating and approaching the trolley. Alternatively, a LiDar reflector from the trolley can be used. Even before it reaches the trolley, the cleaning robot preferably sends the admission request to the controller. If the lift system is unoccupied, the requesting cleaning robot can drive directly onto the receiving element. If the lift system is occupied by another cleaning robot, the requesting cleaning robot remains in a waiting position in the immediate vicinity of the trolley until it receives an unoccupied signal from the controller. If the cleaning robot is in the right position on the receiving element, it preferably goes back into the pause mode. The lift system then brings the cleaning robot in front of the storage compartment assigned to it. The lift system preferably works in the same way as when bringing out the cleaning robot. If the storage compartment assigned to the cleaning robot arranged on the receiving element has been reached, the controller preferably sends a signal to the cleaning robot for entry. Said robot then preferably ends the pause mode and drives straight into the storage compartment. As soon as the cleaning robot is arranged in the storage compartment, the controller preferably signals the clearance for the continued travel of the receiving element onto the lift system. Said lift system can then move the receiving element back toward the substrate and, if necessary, receive additional cleaning robots.

Furthermore, the disclosure relates to a cleaning system comprising a trolley and a plurality of cleaning robots, which is designed to carry out a method according to one or more of the embodiments described above.

The cleaning robots that can be stowed or stored in the trolley are preferably vacuum and/or wiping robots, more preferably vacuum robots that are autonomous and self-propelled. Preferably at least two, preferably at least 3 to 15, more preferably 4 to 10 cleaning robots can be stowed in the trolley.

The trolley is preferably designed for stowage and preferably suction and supplying power to the cleaning robot. The trolley preferably comprises the lift system, a suction system that is designed to empty the cleaning robots, and a power supply unit that is designed to be connected to a power grid. The trolley preferably comprises the storage compartments for stowing the cleaning robots. Furthermore, it preferably comprises transport rollers that are designed to move the trolley over a substrate when it is pushed or pulled by the user.

The trolley preferably has at least one door element which can be arranged in such a way that it closes or opens the foldable receiving element. The door element together with the outer walls of the trolley forms a housing which, when the door element is closed, completely encloses the trolley interior. The cleaning robots stowed in the trolley and the interior of the trolley are completely encased. The door element protects the individual cleaning robots from theft or damage from external influences during storage in the trolley.

The trolley preferably comprises the power supply unit, which is designed to supply the trolley and the cleaning robots stowed in it with electrical energy. In other words, the power supply unit is designed to supply electrical energy to all the components of the trolley and also to the power storage units of the cleaning robots. The trolley can have a mains connection for charging the power supply unit. The mains connection can be easily disconnected from the mains if required when the trolley is to be moved to a site of operation. Alternatively or additionally, the power supply unit is arranged in and/or on the trolley in a removable manner in the form of a rechargeable battery. The power supply unit enables cleaning operation that is largely autonomous from existing connections to the building's power supply network. In addition, the omission of a mains connection cable, which would otherwise be required, increases the degree of mobility of the trolley. In addition, the use of a rechargeable battery as a power supply unit can be advantageous because commercial areas usually have a manageable number of sockets, and the trolley can be positioned freely on the area to be cleaned and is not tied to sockets locally. In this way, the most sensible positioning on the surface to be cleaned can be selected with regard to efficient use of the cleaning robot fleet.

Each storage compartment preferably has a charging contact which is designed to make contact with a cleaning robot arranged in the corresponding storage compartment in order to supply the cleaning robot with power by means of the power supply unit. The cleaning robots can use a detection of the charging contact in order to be correctly positioned in the storage compartment into which they enter.

### BRIEF DESCRIPTION OF THE DRAWINGS

An exemplary embodiment of the disclosure is shown purely schematically in the drawings and will be described in more detail below. In the drawings, which are schematic and not to scale:

FIGS. 1 to 9 show a partial sequence of a method according to the disclosure in a partial side/partial cross-sectional view, a partial top-down/partial cross-sectional view, and a cross-sectional view of a cleaning system according to the disclosure.

### DETAILED DESCRIPTION OF THE DRAWINGS

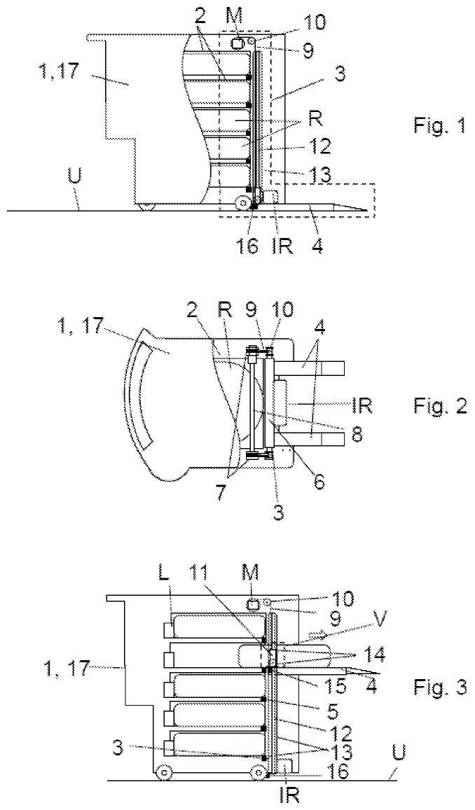

FIGS. 1 to 9 show a partial sequence of a method according to the disclosure in a partial side/partial cross-sectional view, a partial top-down/partial cross-sectional view, and a cross-sectional view of a cleaning system according to the disclosure. The method according to the disclosure is a method for bringing cleaning robots R into and out of a trolley 1, in which each cleaning robot R is automatically placed into the trolley 1 individually and the cleaning robots R are automatically brought out from the trolley 1 in a sequence depending on the cleaning effort assigned to them or in a sequence defined by a user (not shown) of the trolley 1. The automatic bringing out of one of the cleaning robots R is shown in FIGS. 1 to 9. The other cleaning robots R are brought out analogously, which is not shown here. The automatic bringing in of the cleaning robots after completing their cleaning tasks is also analogous to the bringing out, which is not shown here.

FIG. 1 shows a partial side/partial cross-sectional view of the cleaning system of the present disclosure in an operative working position. The cleaning system comprises a trolley 1 and a multiplicity of cleaning robots R. The trolley 1 is designed to store the cleaning robots R outside of a cleaning phase in which they perform their cleaning tasks. In the operational working position, the trolley 1 is ready for the cleaning robots R to be brought in and out, wherein each cleaning robot R is automatically brought individually into the trolley 1 and the cleaning robots R are automatically brought out of the trolley 1 in an order depending on the cleaning effort assigned to them or in an order defined by a user (not shown) of the trolley 1. The trolley 1 has a multiplicity of storage compartments 2 which are stacked vertically one above the other and are each designed to receive one of the cleaning robots R. The storage compartments 2 are housed in a housing 17.

The trolley 1 also has a lift system 3 which can be moved vertically so that the cleaning robots R can be transported individually to or away from one of the storage compartments 2 and can be moved between a substrate U on which the trolley 1 is in the operational working position. The lift system 3 has a receiving element 4 on which a single cleaning robot R can be arranged and which can be moved vertically by the lift system 3. In order to be moved, the cleaning robots R drive onto the receiving element 4 in order to arrange themselves thereon. In order to correctly position one of the cleaning robots R on the receiving element 4, the trolley 1 comprises an IR interface IR and an end position sensor 16 which support the cleaning robot R in question in its positioning on the receiving element 4. In order to move the receiving element 4 vertically, an electric motor M, a deflection roller 10, a cable 9, a guide channel 13, and a guide rod 12 are provided. In FIG. 1, the trolley is shown ready to deploy the cleaning robots R stored therein onto a substrate U on which the trolley 1 is standing. The trolley 1 comprises a controller (not shown) that determines an assigned cleaning effort for each of the cleaning robots R and automatically controls deployment of the cleaning robots R according to their cleaning effort in a specified order.

FIG. 2 shows a partial top-down/partial cross-sectional view of the cleaning system shown in FIG. 1 in the same operational working position as in FIG. 1. The trolley 1 also comprises two cable winches 7 and it comprises a web 6 which connects two vertically moved loading ramps which form the receiving element 4 and can be moved synchronously by means of the web 6.

The vertical movement of the loading ramps works according to a “forklift” principle using the two synchronously running cable winches 7. The cable winches 7 are coupled to one another by means of the shaft 8, to which the electric motor M is attached, which is moved on command of the controller (not shown) of the trolley 1.

FIG. 3 shows a partial side/partial cross-sectional view of the cleaning system shown in FIG. 1 in an additional operative position. The receiving element 4 is moved vertically from the substrate to one of the storage compartments 2, so that the cleaning robot R housed in this storage compartment 2 moves independently onto the receiving element 4, as indicated by an arrow. Each storage compartment 2 has a charging contact L which is designed to supply the cleaning robot R located in the storage compartment 2 with power by means of a power supply device (not shown) of the trolley 1.

The controller (not shown) has determined that the second-highest cleaning robot R has the greatest cleaning effort and should be brought out first. Accordingly, the receiving element 4 is moved to the second-top storage compartment 2 in order to bring out this cleaning robot R. In order to move the receiving element 4, the two cables 9 are brought over the deflection rollers 10 in the desired vertical direction of travel. They are each connected to one of two carriages 11, which, in turn, have a fixed connection to the web 6. The carriages 11 are guided vertically by means of the guide rod 12 and the guide channel 13. Canting of the carriage 11 is prevented by two rollers 14 each that are attached to the carriages 11 and rest or roll on the surfaces of the guide channel 13.

The precise approach of the storage compartments 2 is carried out by end position sensors 5, 15. For this purpose, corresponding sensors and/or actuators 5, 15 are installed on the storage compartments 2 themselves and on the web 6. If the controller (not shown) gives the command to remove a cleaning robot R from its storage compartment 2, the carriages 11 together with the web 6 and receiving element 4 move to the defined end position directly in front of the corresponding storage compartment 2. When the end position is reached, the controller sends a start signal to the corresponding cleaning robot R via a communication interface. The cleaning robot R in question then drives backward out of its storage compartment 2 over the web 6 onto the receiving element 4.

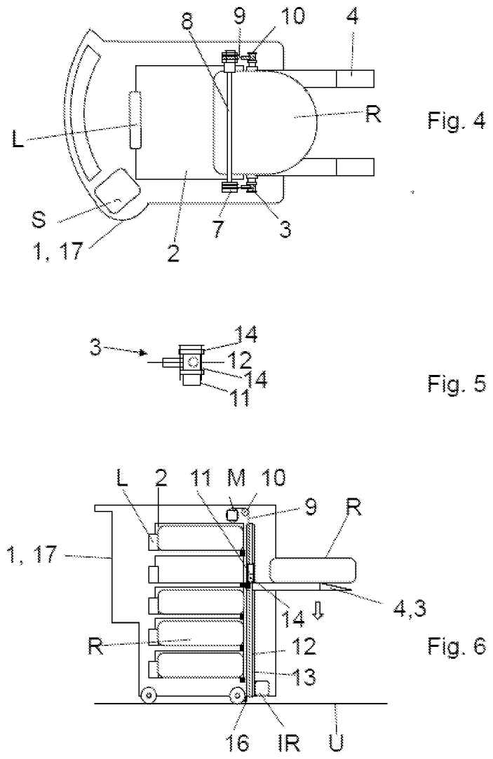

FIG. 4 shows a top-down view of the cleaning system shown in FIG. 3 in the same additional working position as in FIG. 3, the upper outer wall being omitted. The trolley 1 comprises the controller S. The cleaning robot R drives onto the two loading ramps.

FIG. 5 shows an enlarged partial cross-sectional view (labeled V) of the cleaning system shown in FIG. 3. Part of the lift system 3 is shown with the carriage 11, the guide rod 12, and the rollers 14.

FIG. 6 shows a cross-sectional view of the cleaning system shown in FIG. 1 in yet another working position. The cleaning robot R driving out of its storage compartment 2 in FIG. 3 has left its storage compartment 2 and positioned itself completely on the receiving element 4, which is then moved vertically by means of the lift system 3 in the direction of the substrate U, as indicated by an arrow.

The cleaning robot R stops reversing when leaving its storage compartment 2 and enters a pause mode as soon as the end of the receiving element 4 is reached. The detection of an end position of the cleaning robot R can be implemented via crash sensors (not shown) installed therein. The cleaning robot R itself detects its position and sends a signal to the controller (not shown) of the trolley 1 that it has completely driven out of its storage compartment 2 and the pause mode is activated.

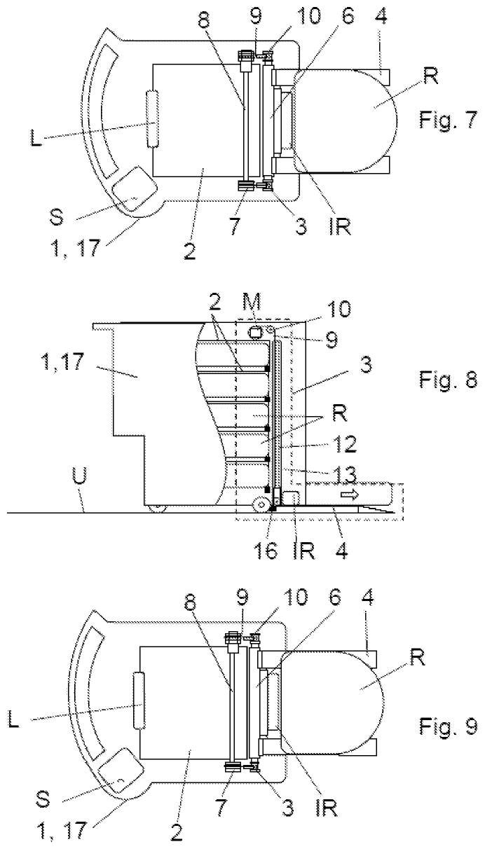

FIG. 7 shows an additional top-down view of the cleaning system shown in FIG. 6 in the same additional working position as in FIG. 6, the upper outer wall being omitted. The cleaning robot R is arranged entirely on the receiving element 4 while being moved vertically to the substrate (not shown). At the command of the controller S, the electric motor (not shown) moves the shaft 8 so that the receiving element 4 together with the cleaning robot R is moved downward in the direction of the substrate (not shown).

FIG. 8 shows an additional cross-sectional view of the cleaning system shown in FIG. 1 in yet another working position. The cross-sectional view shown in FIG. 8 corresponds to the cross-sectional view shown in FIG. 6 with the difference that the receiving element 4 rests on the substrate U, and the cleaning robot R begins to drive from the receiving element 4 onto the ground U, as indicated by an arrow.

When the receiving element 4 together with the cleaning robot R reaches the substrate U, this is again detected by the end position sensor 16 and the controller (not shown) stops the electric motor M.

FIG. 9 shows an additional top-down view of the cleaning system shown in FIG. 8 in the same additional working position as in FIG. 8, the upper outer wall being omitted. The cross-sectional view of the cleaning system shown in FIG. 9 corresponds to the cleaning system shown in FIG. 7 with the difference that the receiving element 4 is arranged on the substrate U (not shown) and the cleaning robot R begins to drive from the receiving element 4 onto the ground.

When the receiving element 4 together with the cleaning robot R reach the substrate (not shown), the infrared interface IR is located directly in front of the cleaning robot R. The controller S sends a signal to the cleaning robot R to start the cleaning run. The cleaning robot R then detects the infrared interface IR directly in front of it and records said interface on its digital map as the start point and end point of its cleaning activity. The cleaning robot R then drives away from the receiving element 4 and begins cleaning the substrate. The controller S can use the infrared interface IR to determine whether the cleaning robot R has left the receiving element 4.

### LIST OF REFERENCE SYMBOLS

A Suction system
L Charging contact
M Electric motor
R Cleaning robot
S Controller
1 Trolley
2 Storage compartment
3 Lift system
4 Receiving element
5 Sensor/actuator
6 Web
7 Cable winch
8 Shaft
9 Cable
10 Deflection roller
11 Carriage
12 Guide rod
13 Guide channel
14 Roller
15 Sensor/actuator
16 End position sensor
17 Housing

1. A method for bringing cleaning robots into and out of a trolley comprising the steps of:
bringing each cleaning robot automatically into the trolley individually; and
bringing the cleaning robots automatically out of the trolley in a sequence depending on the cleaning effort assigned to them or in an order specified by a user of the trolley.

2. The method according to claim 1, wherein, in order to bring the cleaning robots out of the trolley in a sequence depending on the cleaning work assigned to them, respective cleaning, task, and/or map data and an identification of the individual cleaning robots are transmitted from the cleaning robots to the trolley and the trolley uses the cleaning, task, and/or map data to calculate the output sequence of the cleaning robots.

3. The method according to claim 1, wherein each cleaning robot is brought into the trolley as soon as each cleaning robot sends the trolley a signal for bringing in, or in that each cleaning robot is brought into the trolley in a sequence specified by a user.

4. The method according to claim 1, wherein the trolley comprises a plurality of storage compartments, and in that, for each of the cleaning robots, a corresponding storage compartment of the plurality of storage compartments is determined, into which a cleaning robot is automatically brought.

5. The method according to claim 4, wherein, when and/or after one of the cleaning robots is brought into the specific storage compartment, its cleaning, task, and/or map data and its ID are linked to the specific storage compartment.

6. The method according to claim 4, wherein the step of bringing in the cleaning robots comprises the steps of driving a cleaning robot to be brought in onto a receiving element of a lift system of the trolley, vertically moving the receiving element to the specific storage compartment, and driving the cleaning robot into the storage compartment, and
wherein the step of bringing out one of the cleaning robots comprises the steps of vertically moving the receiving element of the lift system to the specific storage compartment, driving the cleaning robot stowed in the storage compartment onto the receiving element, vertically moving the receiving element until it reaches a substrate on which the trolley stands, and driving the cleaning robot from the receiving element onto the ground.

7. The method according to claim 6, wherein, while the cleaning robot to be brought out is moving out of or into the storage compartment, and end position of the cleaning robot is detected, and/or in that the cleaning robot to be brought in or out is in a pause mode while being moved by the lift system.

8. The method according to claim 1, wherein, when a cleaning robot is and/or after being brought out of the trolley, the cleaning robot receives a signal to start its cleaning, and/or wherein, when leaving the lift system, the cleaning robot records its position as the start point and end point of its cleaning to be carried out in map data stored in said robot or in a map to be newly created.

9. The method according to claim 1, wherein, after one of the cleaning robots has been deployed, the trolley detects whether the deployed cleaning robot has left the trolley.

10. A cleaning system comprising a trolley and a plurality of cleaning robots, configured to carry out the method according to claim 1.
